(19) United States
(12) Patent Application Publication
(10) Pub. No.: US 2011/0166862 A1
(43) Pub. Date: Jul. 7, 2011

(54) SYSTEM AND METHOD FOR VARIABLE AUTOMATED RESPONSE TO REMOTE VERBAL INPUT AT A MOBILE DEVICE

(76) Inventors: Eyal ESHED, Bnei Atarot (IL); Ariel Velikovsky, Modi'in (IL); Sherrie Ellen Shammass, Gedera (IL)

(21) Appl. No.: 12/984,036

(22) Filed: Jan. 4, 2011

Related U.S. Application Data
(60) Provisional application No. 61/291,969, filed on Jan. 4, 2010.

(51) Int. Cl. G10L 21/00

(52) U.S. Cl. 704/270; 704/E15.001

(57) ABSTRACT

A method and system for altering an operational mode of evaluating and responding to verbal input from a user to a mobile device if conditions make such evaluation incompatible with a favorable user experience. Automated speech recognition (ASR) evaluation of verbal input may be performed on a mobile platform to continue a flow of the user experience. Evaluation of the verbal input may continue at a backend when conditions allow for transmission of recorded input to the backend.

### CROSS REFERENCE TO RELATED APPLICATION

This application claims priority from U.S. Provisional Patent Application No. 61/291,969, filed on Jan. 4, 2010 and entitled ‘System and Method for Adaptive Speech Driven Mobile Learning Platform’, incorporated by reference herein in its entirety.

### FIELD OF THE INVENTION

The present invention generally relates to portable computerized voice recognition systems, and particularly, to responding to verbal input made at a mobile device from either the platform itself or from a remote server.

### BACKGROUND OF THE INVENTION

Various systems provide computerized responses to verbal input a user makes. Frequently, such systems rely on a voice recognition function to interpret the verbal input from a user, where the verbal input from the user is made to or input to a mobile platform such as cellular telephone phone or other portable, computerized device. A reply to an interpreted verbal input is selected or generated by a computerized system, frequently from a remote server, and is provided to the user by way of the cell phone or other portable device.

A factor in a user's satisfaction with such as system is the smoothness or timeliness of the responses provided by the system. Delays, inability of the system to provide a timely response or failure of the system to recognize a user's verbal input may frustrate the user, spoil the user's experience and damage the reputation of a provider of the response.

### SUMMARY OF EMBODIMENTS OF THE INVENTION

Embodiments of the invention may include a method for selecting a response to a verbal input from a user, where the verbal input is made to a mobile transmitting device, where the method includes determining whether the verbal input is to be evaluated by a computerized speech recognition module at a remote computer in a first period; selecting a response from the mobile device if the verbal input is not to be evaluated by the computerized speech recognition module at the remote computer in the first period; and selecting a response at the remote computer if the verbal input is to be evaluated by a computerized speech recognition at the remote computer in the first period. In some embodiments the method may include recording the verbal input at the mobile transmitting device, and delivering the verbal input to the remote computer in a second period.

In some embodiments the method may include determining that the verbal input will not be received at the remote computer from the mobile transmitting device in the first period. In some embodiments the method may include determining that the verbal response includes noise levels that prevent the evaluation by a speech recognition function of the remote computer. In some embodiments the method may include determining whether audio data in the verbal input is not suitable to be evaluated by a speech recognition function of the remote computer. In some embodiments the method may include determining whether the mobile transmitting device includes voice recognition capabilities. In some embodiments a method may include evaluating the verbal input at the mobile transmitting device. In some embodiments a method may include selecting a linear response to the verbal input.

Some embodiments of the invention may include a method for providing a computerized response to a verbal input made to a mobile device, where the method includes providing a linear branch mode response to the verbal input in a first period; and providing a dual branch mode response to the verbal input in a second period.

Some embodiments of the invention may include a method for transmitting a recording of the verbal input to a remote computer; evaluating the verbal input at the remote computer in the second period; and transmitting a result of the evaluation to the mobile device in the second period.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic diagram of components of a system-architecture in accordance with an embodiment of the invention;

FIG. 2 is a schematic diagram of a flow of control signals, data and inputs between a device and a remote backend server, in accordance with an embodiment of the invention;

FIG. 3 is a flow diagram of run-time adaptive behavior such as adaptation to environmental noise, poor network conditions and user circumstances in accordance with an embodiment of the present invention;

FIG. 4 is a schematic diagram a flow of actions including employment of both local and remote ASR resources, in accordance with an embodiment of the invention;

FIG. 5 is a flow diagram of client-side adaptation in accordance with an embodiment of the invention;

FIG. 6 is flow diagram of a server-side adaptation in accordance with an embodiment of the invention; and

FIG. 7 is a flow diagram of a method in accordance with an embodiment of the invention.

### DETAILED DESCRIPTION OF THE PREFERRED EMBODIMENTS

In the following description, various embodiments of the invention will be described. For purposes of explanation, specific examples are set forth in order to provide a thorough understanding of at least one embodiment of the invention. However, it will also be apparent to one skilled in the art that other embodiments of the invention are not limited to the examples described herein. Furthermore, well-known features may be omitted or simplified in order not to obscure embodiments of the invention described herein.

Unless specifically stated otherwise, as apparent from the following discussions, it is appreciated that throughout the specification, discussions utilizing terms such as “switching”, “adding”, “associating” “selecting,” “evaluating,” “processing,” “computing,” “calculating,” “determining,” “designating,” “allocating” or the like, refer to the actions and/or processes of a computer, computer processor or computing system, or similar electronic computing device, that manipulate, execute and/or transform data represented as physical, such as electronic, quantities within the computing system's registers and/or memories into other data similarly represented as physical quantities within the computing system's memories, registers or other such information storage, transmission or display devices.

As used in this application, and in addition to its regular meaning, the term “mobile transmitting device” may include for example, a cellular telephone, a table computer, laptop computer, netbook computer or other device having a processor, a memory, a transmitter receiver as well as an input and output device such as a screen, keypad, touch screen, microphone, speakers or other input and output device.

As used in this application, and in addition to its regular meaning, the term “verbal input” may include one or more spoken words, phrases, sentences, paragraphs or other responses that may be spoken by a person and detected by a microphone or other input device that may be associated with a mobile transmitting device.

As used in this application, and in addition to its regular meaning, the term “evaluating” may include detecting a verbal input for mistakes or mispronunciations, for poor diction, grammar, accent, or other imperfections that are associated with a process or learning a language.

As used in this application, and in addition to its regular meaning, the term prompt, may include a signal to a user that may be generated by a local or remote computer, where such signal requests that the user take an action such as saying a word or other verbal input, or responding to a question or request, where such respond may include an input to a computer or other input device.

As used in this application, and in addition to its regular meaning, the term “remote computer” may include a processor, memory or other device suitable to execute software instructions that may be associated with a remote device over a network such as a wired, wireless or other network.

An embodiment of the invention may be practiced through the execution of instructions such as software that may be stored on an article such as a disc, memory device or other mass data storage article. Such instructions may be for example loaded into a processor and executed on one or more computerized platforms. It will also be appreciated that while embodiments of the current invention are primarily described in the form of methods and devices, the invention may also be embodied, at least in part, in a computer program product as well as a system comprising a computer processor and a memory coupled to the processor, wherein the memory is encoded with one or more programs that may perform the functions disclosed herein.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein.

As used in this application, the term user device may include a cell phone, wi-fi device, mobile computer, personal digital assistant, tablet computer or other electronic device that may include one or more of a processor, memory, input device and microphone.

As used in this application, the term ‘application flow’ or ‘application mode’ may include one or more functional patterns implemented by a system for prompting input by a user and responding to such input. For example, a system may implement a linear branch application mode, where questions or prompts for verbal input are provided to the user, but where a second or subsequent prompt is not necessarily responsive to the verbal input of the user provided in response to the first prompt. Another mode may be described as dual branch mode, where a second prompt or request to a user for verbal input is responsive or otherwise influenced or effected by a prior verbal input from the user. For example, in linear branch mode, a first prompt or request for verbal input may be “what is your name”, to which the user may respond, “Sam”. A second request may be “where do you live” to which a user may respond “France”. In dual branch mode, the first two requests may be the same, but a third request could be “What kind of weather are they having these days in France, Sam?” In this mode, subsequent requests or prompts may be influenced or customized to the prior inputs of the user. Other modes of operation that may include combinations of modes are also possible.

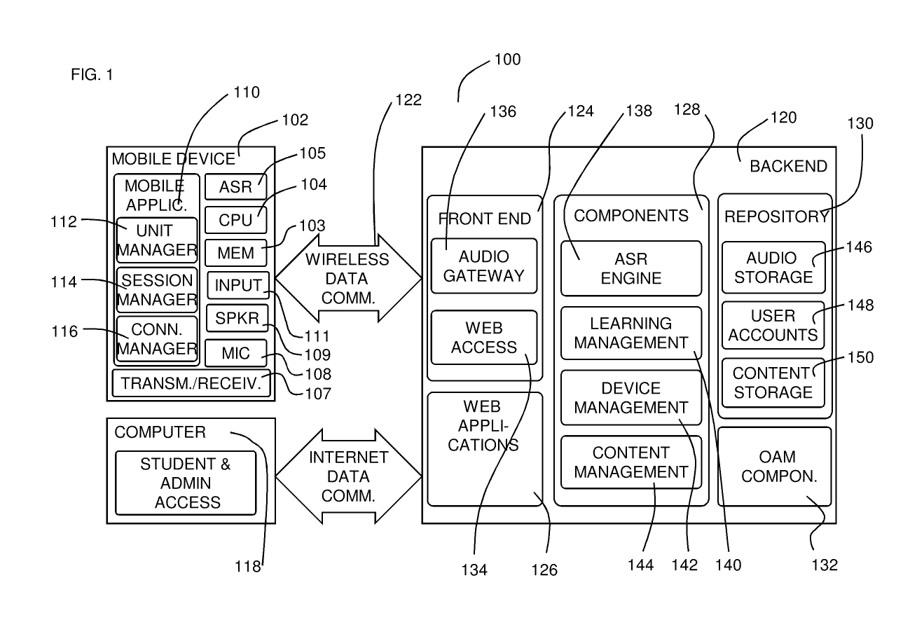

Reference is made to FIG. 1, a schematic diagram of components of a system architecture in accordance with an embodiment of the invention. In some embodiments, system 100 may include a user device 102 that may have a processor 104, a memory 106, a receiver/transmitter such as antenna 107, and a microphone 108 or other voice input device 111 such as for example a keyboard or mouse. Memory 106 may include random access memory or other mass data storage capacity that may be suitable to record and store voice data as well as software or instructions that may be executed by processor 104 Device 102 may also include transmission and reception functions of wireless data. Memory 103 may also store a group of software modules that make up a client portion of the mobile application 110 of system 100. Mobile application 110 may include a unit manager 112 software module, a session manager 114 software module and a connection manager 116 software module. In some embodiments, device 102 may include an automated speech recognition module 105. In some embodiments, mobile application 110 may be run on a personal computer 118 that is not mobile. Modules or software 110, 112, 114, and 116 may be executed by processor 104 such that it may be considered that processor 104 is or carries out the functionality of these or other modules described herein.

Unit Manager 112 may present for example learning content or other material to a user and may control an operation or flow of data, responses or output that is transmitted or conveyed from system 100 to a user by way of device 102. Session manager 114 may control authentication, speech recognition functionality and additional content delivery from device 102 to system 100. Connection manager 116 may track, monitor and handle a flow of data over a wireless connection 122 or network from device 100 to backend 120.

Backend 120 may include a processor and a memory, and one or more of such processors or memory units may execute one or more of the functions of Web applications 126, components 128, system repository 130 and Operation, Administration and Maintenance (OAM) 132 components such that it may be considered that a processor of backend 120 is or carries out the functionality of these or other modules described herein. In some embodiments, one or more software and hardware modules that may be included in one or more servers, work stations or other computer devices of backend 120 may be connected to or associated with a wireless network that may receive and transmit voice or other data using wireless connection 122 Backend 120 may include modules such as frontend, Web applications 126, components 128, system repository 130 and Operation, Administration and Maintenance (OAM) 132 components.

Frontend 124 may include a web server 134 interface and an audio gateway 136. Web server 134 may handle web requests coming from the Internetor network-based applications as well as session based communication with device 102. Audio gateway 136 may receive recorded audio from device 102 and return recognition and feedback results after interpretation or evaluation by automated speech recognition (ASR) engine 138 of the audio or verbal input received by device 102 from a user of device 102.

Web applications 126 may include one or more web based applications, such as for example an educational tool that enables a user to learn a new language, a customer service solution with automated replies to particular questions, or other applications that accept verbal input from a user and respond with relevant data. In some embodiments, an application may allow a user to monitor his/her progress as is evident from the verbal input of the user, and may allow an update of the user's profile as is evidenced from the verbal input. Such update may alter an application setting. For example, a user who is using an application to learn a new language, may speak or provide a verbal input to a prompt. The verbal input may be evaluated by for example web application 126, and the language learning application may be reset to a higher level to account for the progress of the user as is evidenced by his response to the prompt. Web application 126 may include an authoring tool that enables updating content, for example by an educational staff.

Component 128 may include ASR 138, learning management server 140 (LMS), device management system 142 (DMS) and content management system 144 (CMS). ASR 138 may process and evaluate the verbal input and provide feedback on the content and quality of the speech. LMS 140 may manage the general learning process and adaptive assignment of the learning tasks to the user. DMS 142 may recognize or identify device 102, such as the mobile phone make and type, and adaptation of the learning content to the specific capabilities of device 102. CMS 144 may manage the learning content and enable authoring of existing and new content.

System repository 130 may include audio storage 146, user account 148 and content storage 150. Audio storage 146 may include stored or recorded voice or audio data received from device 102. User accounts 148 may include a user account, profile and identification data such as credentials, course registration information, learning preferences and study level. Content storage 150 may store learning content such as text, images, audio, video, and multimedia items as well as course definitions and auxiliary data. OAM 132 may include components or modules to handle administrative tasks such as system configuration, monitoring and maintenance.

In operation, a user may input verbal or voice data into device 102. For example, a user may speak or type into device 102. System 100 may determine that for some reason, the verbal input from the user will not be evaluated by the ASR 138 of backend 120 in time for a response to the verbal input to be received by user within the desired time period necessary to preserve a flow of the user's experience with the application of system 100. In some embodiments a desired time period needed to retain a flow of a language learning application may be from approximately two seconds to approximately 5 seconds, though other periods are possible. In some embodiments, the time period may approximate a duration of an exchange of dialogue between two parties to a conversation, so that the period between a verbal input by a user and an expected response by the system is comparable to the time period between a statement by a first party to a conversation and a reply by a second conversation. To prevent such a delay, a response may be provided to the verbal input by some a language learning function or application that may have been loaded into device 102, and such response may be provided within the desired time framework. The recorded or stored verbal input may be transmitted to backend 120 when transmission and evaluation become possible, and the evaluation or response from backend 120 may be transmitted to device 102 at a later period. Among the reasons for not receiving a timely evaluation from backend 120 may be loss of network connectivity, high signal to noise ratio, incomprehensible speech or others. An interim response to verbal input from device 102 may be facilitated by using an ASR 105 function of device 102, by altering a mode from dual branch to linear branch, or by some other method.

In some embodiments, one or more responses and prompts may be loaded in advance or at some other times into memory 103 of device 102, and such pre-loaded prompts, responses or requests for verbal input may be triggered by for example an application for language instruction that was loaded into device 102.

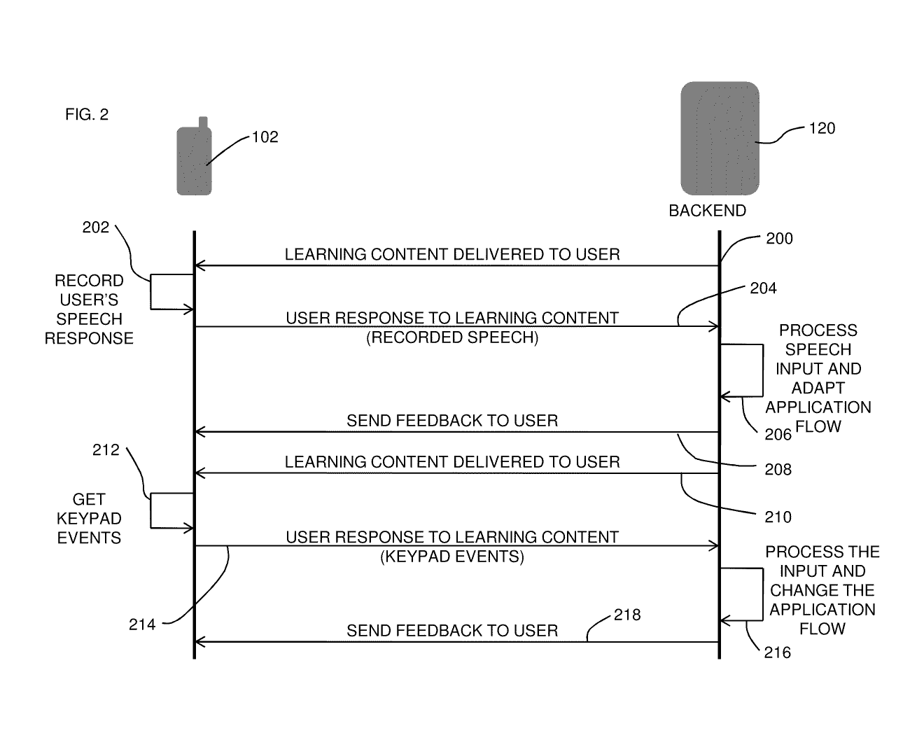

Reference is made to FIG. 2, a schematic diagram of a flow of data and input between device 102 and backend 120, in accordance with an embodiment of the invention. In an initialization phase in action 200, learning content may be delivered from the backend 120 to device 102. Learning content may include for example an exploration of a teaching point, practice session or testing session. Such content may be or include text, audio based content or multimedia content. The content may trigger user's response in action 202, such as a verbal input. In action 204, such response may be recorded by device 102 and sent to backend 120.

In action 206, backend 120 may process or evaluate the verbal input, and in action 208, backend 120 may adapt feedback according to the evaluation results and send the feedback to device 102. For example, a verbal input may include one or more errors that are detected by ASR 138, and a response from backend 120 may in block 210 include a correction of such errors and a change in the lesson flow to review content that was earlier introduced to a user.

In some instances, if for example system 100 does not recognize a verbal input because the input is below a recognition threshold of ASR 138 because for example an accent of the user makes the verbal input unintelligible to the ASR 138, system 100 may present feedback to the user by way of a prompt over a loudspeaker of device 102 or by a signal or message appearing on a screen, display or other output function of device 102, to move to a more quiet environment. In action 212, system 100 may request or display a message or prompt to user by way of device 102 that the user use keypad strokes instead of speech input to select options if system 100 cannot recognize verbal input instructions. In action 214, a user may respond to the request or presented content with keystrokes or other inputs. In action 216, backend 120 may process the input from the keystrokes and alter a content or flow of the application of system 102, and then, in action 218, system 100 may deliver the altered contact of application flow to device 102.

In some embodiments, recorded input may include, in addition to the verbal input of the user, various levels of noise as well as periods of silence creating varying levels of signal to noise ratios (SNR), and the input silence and noise may be fed into ASR 138 or other audio input processing engines. Verbal input may be further evaluated to detect threshold levels of SNR, duration and confidence, and system 100 may deliver feedback to the user via device 102 in response to such evaluations. For example, a verbal input may have been recorded with an intensity that is too low, resulting in high SNR that does not meet the SNR threshold of ASR 138 or of other input processing engines. In such case, system 100 may request user to speak more loudly and utter the verbal input again.

Yet another example of keypad events usage could be in the assessment stage where the user may input answers to the keypad. In this case, the user is presented with a number of tests such as multiple choice questions. While in a typical speech-driven scenario the user would make the answer selection by just saying the answer, when the speech input is impossible, the user will be able to use the mobile device keypad to select and enter the correct answer.

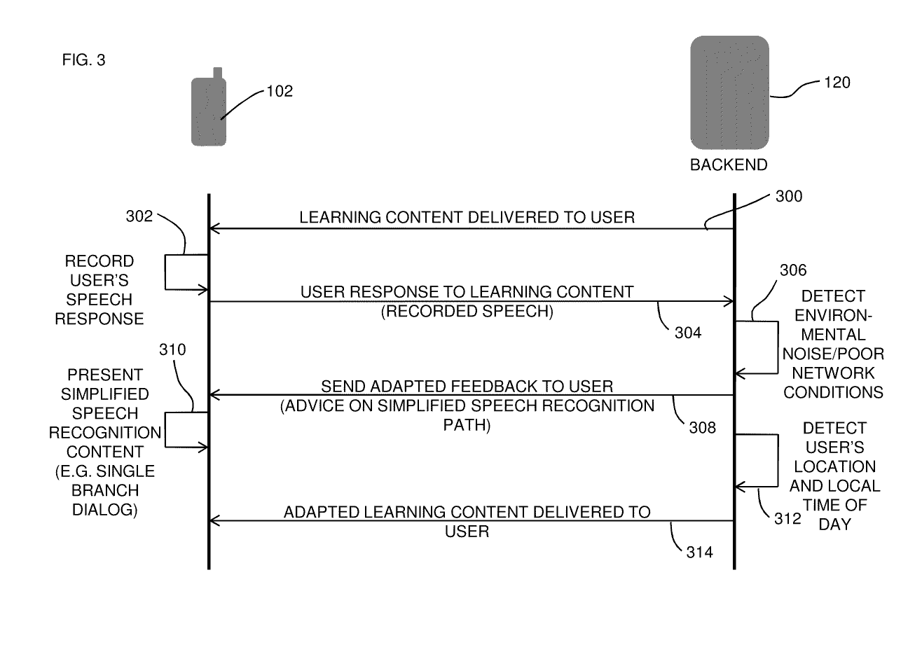

Reference is made to FIG. 3, a possible run-time adaptation flow in accordance with an embodiment of the invention. In action 300, system 100 may present content to the user by way of device 102. In actions 302 and 304, device 102 may record the user's response and transmit the recorded voice data to backend 120. In action 306, a module of system 100 detects unusual environmental events such as high background noise or poor network conditions. In such case and in action, the application flow may be altered to adapt for the environmental noise, and the adapted feedback may be delivered in action 308 to device 102. For example, an adaptation may include a request that the user simplify speech input to a selectable choice of phrases, or repeat a word or response to account for limited availability of network bandwidth. Another example of an adaptation, as in action 310 may be a switch from a dual branch mode to a linear branch mode. A further example an in action 312 may be a recognition by system 100 of an environmental factor such as a known location or time of day, and a request for input by the user may be crafted to account for such factors. In such case as in action 314, delivered content may be adapted to match the user's environment and enable a more engaging interaction.

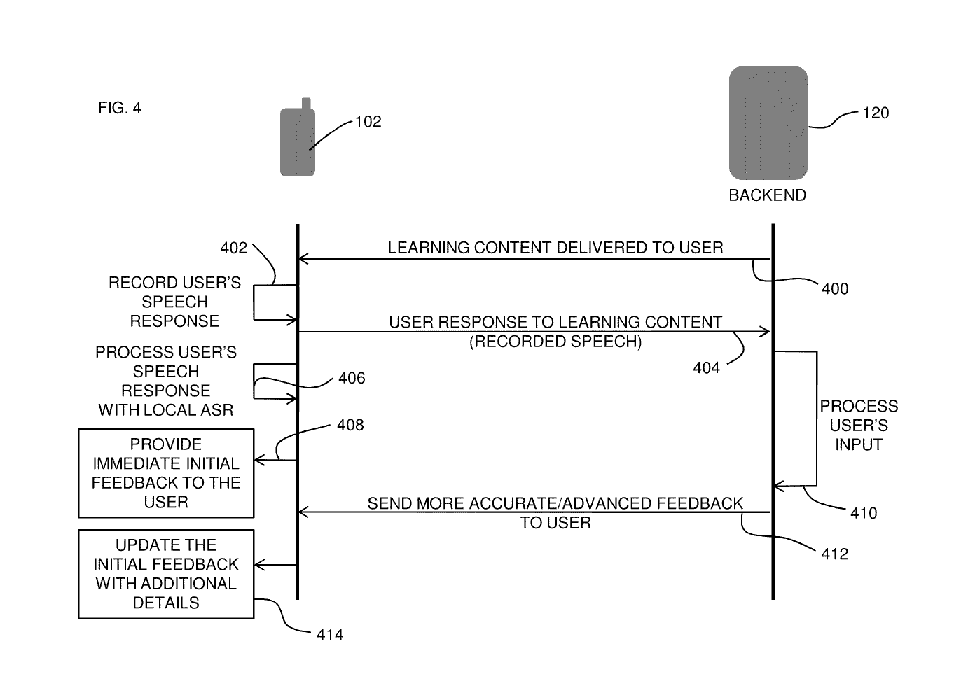

Reference is made to FIG. 4, a flow of actions including employment of both local and remote ASR resources, in accordance with an embodiment of the invention. In this scenario device 102 may be equipped with for example a limited ASR functionality, while backend 120 may include a more powerful ASR function. In action 400 backend 120 may deliver content to device 102. In action 402 and 404, a user may provide a verbal response and the response may be recorded and delivered to backend 120. In action 406, an ASR function on device 120 may provide an initial evaluation or processing of the verbal input, and in action 408, the user may be prompted based on the evaluation by the device's ASR. In action 410, the recorded verbal input may be further processed by an ASR function at backend 120, and in action 412 results of the further processing may be delivered to device 102, as an update to the prior evaluation as in action 414. In this flow, a user may receive immediate evaluation of his input so as to keep a user experience flowing, while a summary or more accurate or expanded evaluation may be provided from the ASR analysis provided from backend 120.

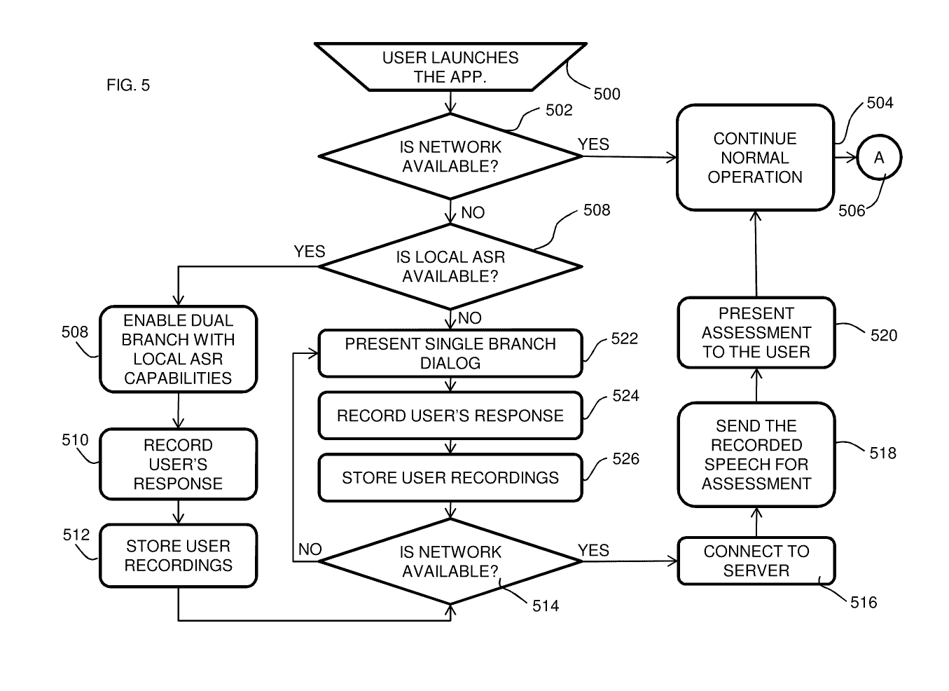

Reference is made to FIG. 5 is a flow diagram of client-side adaptation in accordance with an embodiment of the invention. In block 500, a user may initiate an application on system 100. In block 502, either of device 102 or backend 120 may evaluate whether a network connection is available to sufficiently transmit a recorded verbal input and to receive an instruction in response, and if so, whether a timeliness of such transmission and receipt matches a requirement of system 100. If such transmission is available, a method may continue to block 504, where a flow or mode of the application may assume a default or standard pattern represented by block 506. If such transmission is not available, a method may proceed to block 508 to determine whether device 102 includes ASR functionality. If device 102 includes such functionality, a method may proceed to block 508, and an application may proceed in for example a dual branch mode, such as a limited branch mode, using the ASR of device 102. In blocks 510 and 512, the verbal input may be recorded and sent from device 102 to backend 120. In block 514, system 100 may regularly or periodically check if a recorded verbal input can be transmitted over the network. If such verbal input can then be transmitted, a method may proceed to blocks 516 and 518, where the connection of device 102 to backend 120 may be restored and the recorded verbal input or other user input may be transmitted to backend 120. In block 520, the evaluation of the transmitted user input may be collected and transmitted to user. Normal operation of system 100 in for example a default or selected mode may resume in block 504.

Returning to block 508, if no ASR is available on device 102, an operational mode of system 100 may be altered in block 522 from example a dual branch mode to a single branch mode, and such mode may be managed from device 102 without transmission from backend 120. In blocks 524 and 526, device 102 may record and store verbal input or other input from a user in the single branch mode, and periodically check to see if network access in block 514, whereupon a method may continue to block 516 as above.

In some embodiments, an evaluation done on a device ASR 105 may proceed faster, albeit less thoroughly than an evaluation and response provided by ASR 138. In this way, quick comments or feedbacks to a user may be provided to speed the user's interaction, while a more thorough evaluation and response may be provided at certain intervals once ASR 138 has performed and transmitted its evaluation to device 102.

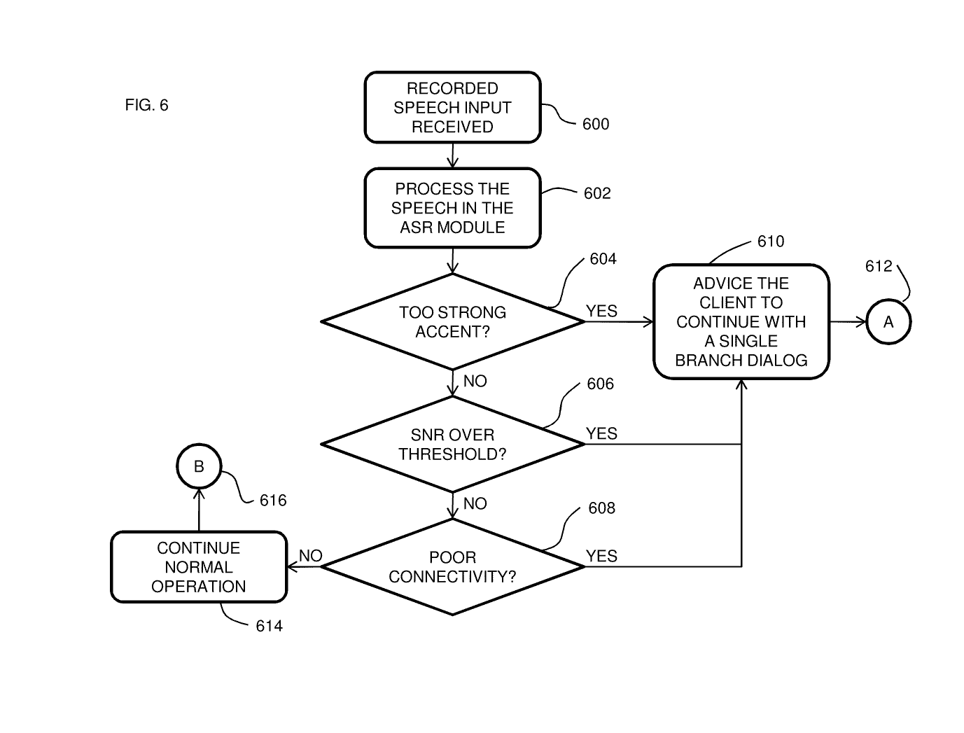

Reference is made to FIG. 6, a flow diagram of a backend flow in accordance with an embodiment of the invention. In block 600 and 602, a device or backend may receive a verbal input from a user and proceed to evaluate the verbal input by way of ASR 105 or ASR 138 or with some other evaluation module. In blocks 604, 606 and 608 a module may determine that a proper evaluation may be impossible or inefficient because of for example the accent of the user is too strong or the user's speech is unclear, or that environmental noise such as SNR is too strong, or that connectivity is too limited to afford transmission of the verbal input. In any of such cases, the method may continue to block 610 where system 100 may suggest to a user, or may automatically change a mode or flow from dual branch to single branch operation in block 612. Returning to block 608, if ASR 105 or ASR 138 is able to evaluate the verbal input, the method may proceed to block 614 where the dual branch flow may be maintained in block 616. The mode may switch from dual to linear either at the request of a user or automatically and may switch back to dual branch when conditions improve.

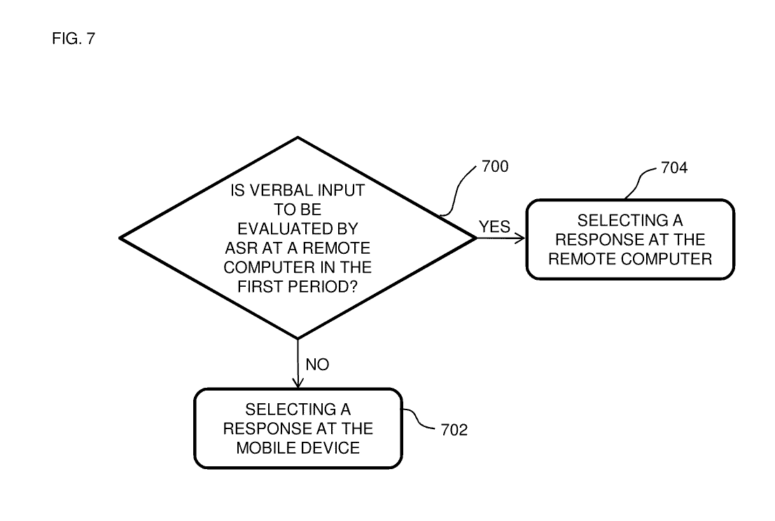

Reference is made to FIG. 7, a flow diagram of a method for selecting a response to a verbal input from a user into a mobile transmitting device. In block 700, a determination may be made that conditions are not suitable in a first time to transmit the verbal input to a backend for evaluation, and that the evaluation is to be made by a module at the mobile client. In block 702, software in the mobile device, e.g., operated by processor 104, may select a response to the verbal input if such conditions are not suitable. In block 704, a response to the verbal input may be selected from a remote backend computer, if conditions are appropriate for such evaluation and transmission.

In some embodiments, the verbal input may be recorded delivered to a backend in a second period when evaluation of the verbal input is possible.

In some embodiments, a determination may be made by a cell phone that the verbal input will not be received during the first period. In some embodiments the first period may be a time period of from one to several seconds, or some other period that may be determined to interrupt a flow of the user experience. In some embodiments, the system may learn the proper interval for the first period from a user's past response or current input that may indicate the user's frustration with the slow pace of the experience. A second period may include any period after the first period or after the interval necessary to maintain a flow of the user's experience with the application, such that an evaluation of a verbal input that results in a response after the first period may be deemed to be a response during the second period.

In some embodiments, an unavailability of the system to evaluate a verbal input may be caused by a noise level in the verbal input that prevents the speech recognition function of the remote computer to interpret the verbal input.

In some embodiments, audio data in the verbal response from the user is not suitable to be evaluated by the speech recognition function of the remote computer.

In some embodiments, the system may detect whether the mobile device includes voice recognition capabilities, and that such ASR may be used to evaluate the verbal input on an interim or temporary basis until a full evaluation can be undertaken by the remote backend computer.

In some embodiments, if a full evaluation of the verbal input is not possible during a first period, the system may alter a mode of the application from a dual branch mode to a linear branch mode, or may combine or alternate linear and dual branch modes to compensate for time delays in evaluation by the backend.

It will be appreciated by persons skilled in the art that embodiments of the invention are not limited by what has been particularly shown and described hereinabove. Rather the scope of at least one embodiment of the invention is defined by the claims below.

1. A method for selecting a response to a verbal input from a user, said verbal input being to a mobile transmitting device, the method comprising:
determining whether said verbal input is to be evaluated in a first time period by a computerized speech recognition module at a remote computer;
selecting said response at said mobile device if said verbal input is not to be evaluated by said computerized speech recognition module at said remote computer in said first time period; and
selecting said response at said remote computer if said verbal input is to be evaluated by said computerized speech recognition at said remote computer in said first time period.

2. The method as in claim 1, comprising recording said verbal input at said mobile transmitting device, and delivering said verbal input to said remote computer in a second period when said verbal input is to be evaluated at said remote computer.

3. The method as claim 1, wherein said determining comprises determining that said verbal input will not be received at said remote computer from said mobile transmitting device in said first time period.

4. The method as in claim 1, wherein said determining comprises determining that said verbal response includes noise levels that prevent said evaluation by a speech recognition function of said remote computer.

5. The method as in claim 1, wherein said determining comprises determining whether audio data in said verbal input is not suitable to be evaluated by a speech recognition function of said remote computer.

6. The method as in claim 1, comprising determining whether said mobile transmitting device includes voice recognition capabilities.

7. The method as in claim 6, comprising evaluating said verbal input at said mobile transmitting device.

8. The method as in claim 1, wherein said selecting said response at said mobile transmitting device comprises selecting a linear response to said verbal input.

9. The method as in claim 1, wherein said selecting said response at said remote computer comprises selecting a dual branch response to said verbal input.

10. A method for providing a computerized response to a verbal input made to a mobile device, the method comprising:
providing a linear branch mode response to said verbal input in a first time period; and
providing a dual branch mode response to said verbal input in a second time period.

11. The method as in claim 10, comprising:
transmitting a recording of said verbal input to a remote computer;
evaluating said verbal input at said remote computer in said second period;
transmitting a result of said evaluation to said mobile device in said second period.

12. The method as in claim 10, comprising determining at said mobile device that said dual branch response to said input will not be available during said first period.

13. The method as in claim 10, comprising evaluating a connection between said mobile device and a remote computer to determine if said dual branch response will be available at said mobile device during said first period

14. An article comprising instructions that when executed by a processor result in:
determining whether a response from a remote computer to a verbal input at a mobile device will be provided in a first time period;
providing a response to said verbal input during said first time period from said mobile device.

15. The article as in claim 14, wherein said execution of said instructions further result in:
transmitting a recording of said verbal input to said remote computer;
evaluating said verbal input at said remote computer; and
transmitting to said mobile device said response from said remote computer during a second time period.

16. The article as in claim 14, wherein said execution of said instructions further result in providing said response to said verbal input during said first time period from said mobile device in a linear branch mode.
